(19) United States
(12) Patent Application Publication
(10) Pub. No.: US 2025/0162941 A1
(43) Pub. Date: May 22, 2025

(54) METHOD FOR CARBONATING WASTE MATERIALS

(71) Applicant: HSustainability GmbH, Heidelberg (DE)

(72) Inventors: Jan SKOCEK, Heidelberg (DE); Tim SCHADE, Heidelberg (DE); Wolfgang DIENEMANN, Heidelberg (DE)

(73) Assignee: HSustainability GmbH, Heidelberg (DE)

(21) Appl. No.: 18/833,956

(22) PCT Filed: Feb. 16, 2023
(86) PCT No.: PCT/EP2023/053958

§ 371 Date: Jul. 29, 2024

(30) Foreign Application Priority Data
Mar. 10, 2022 (EP) 22161403.5
Apr. 1, 2022 (EP) 22166347.9

(51) Int. Cl. C04B 20/02; B01D 53/62; B01D 53/83; B09B 3/40; B09B 3/70; B09B 101/30; B09B 101/45; B09B 101/90; C04B 18/04; C04B 18/08; C04B 18/167

(52) U.S. Cl. CPC C04B 20/023; B01D 53/62; B01D 53/83; B09B 3/40; B09B 3/70; C04B 18/0436; C04B 18/08; C04B 18/167; B01D 2251/402; B01D 2251/404; B01D 2257/504; B01D 2258/0233; B01D 2258/0283; B01D 2258/0291; B09B 2101/30; B09B 2101/45; B09B 2101/90

(57) ABSTRACT

A method for simultaneously drying and carbonating a mineral waste material that includes carbonatable calcium and/or magnesium compounds and/or silicate, aluminate or silicate-aluminate phases in a spray dryer, wherein a starting material slurry is provided including the mineral waste material in the form of particles with a D90≤500 μm and at least 30 wt.-% water, a hot gas is provided including at least 4 Vol.-% CO₂ and fed into the spray dryer, the starting material slurry is sprayed into the hot gas in the spray dryer wherein a temperature of ≥100° C. and a relative humidity of <50% are adjusted in the spray dryer, the starting material slurry is transformed into evaporated water and a dry, carbonated product comprising calcium carbonate and/or one of silica gel or alumina gel or silica-alumina gel, and the dry, carbonated product is separated from the gas and evaporated water.

The present invention relates to a method for carbonating mineral waste materials with simultaneous drying.

Resources are becoming increasingly rare, and the cement industry is looking for ways to recycle concrete and to activate the ground product to use it again as a binder. In the field of standardization, recycled concrete paste (RCP) and fines are already receiving attention in the currently discussed EN 197-6 with the abbreviation “F”. Utilization of the recycled concrete aggregates helps to achieve higher sustainability and preserves the resources of natural aggregates. However, the application of the RCP is limited because of the inappropriate characteristics, e.g. very limited strength contribution and high water demand.

One of the potential ways to make RCP useful is enforced carbonation of the fine fraction from concrete recycling comprising most of the RCP. The extended carbonation of recycled concrete paste has not only potential to bind a significant amount of CO₂ but can also improve the properties of the recycled concrete paste. This in turn will allow to use the carbonated recycled concrete paste (cRCP) as a valuable supplementary cementitious material since after the carbonation cRCP is characterized by pozzolanic properties.

Besides RCP other mineral waste materials containing carbonatable calcium and/or magnesium compounds and/or silicate, aluminate or silicate-aluminate phases with insufficient reactivity in hydraulic and alkali activated binders such as some fly ashes, most bottom ashes, ferrous and non-ferrous slags, but also natural minerals containing calcium and magnesium silicates e.g. mine tailings, can be carbonated and thus activated to transform them into pozzolanic materials.

A multitude of proposals has been made in the prior art for devices and methods to carbonate mineral waste materials, often also achieving some or even an efficient CO₂ sequestration. One example is EP 3 744 700 A1 which also mentions numerous earlier proposals. Therein, a grinding of recycled concrete fines in a carbon dioxide containing atmosphere and subsequent completion of carbonation in a fluidized bed reactor are disclosed. Another approach is found in EP 3 750 619 A1, where exhaust gas shall be scrubbed from CO₂ and SOₓ with a waste material rich in carbonatable calcium and/or magnesium phases. It is explained that efficient scrubbing and carbonation needs a relative humidity from 50 to 100% and recirculation of the waste material into the scrubbing.

The obtainable cRCP and other carbonated waste materials show improved reactivity, often comparable to the currently used and standardized supplementary cementitious materials. However, there is a dilemma as wet carbonation is assumed to be ideal with regard to process simplicity and effectiveness but the product must be dry for mixing with cement. Besides, many mineral waste materials occur as solution or slurry. Therefore, except when the slurries from the carbonation can be used directly as proposed in WO 2021/074003 A1, a drying step is needed which takes time and needs energy. Consequently, the object remains to provide cost-effective, easy to use and fast methods for carbonation.

Surprisingly it was now found that it is possible to carbonate a slurry containing mineral waste materials comprising carbonatable calcium and/or magnesium compounds and/or silicate, aluminate or silicate-aluminate phases in a spray dryer, when the particles in the slurry have a D₉₀≤500 μm, the slurry contains at least 15 wt.-% water, the hot gas provided to the spray dryer comprises at least 4 Vol.-% CO₂, and the temperature in the spray dryer is not less than 100° C. with a relative humidity below 50%. In other words, contrary to current wisdom in the art, the carbonation occurs fast enough under relatively dry conditions to manufacture a dry, carbonated product comprising calcium carbonate and/or one of silica gel or alumina gel or silica-alumina gel showing the desired pozzolanic reactivity without the need to recirculate the material in the reactor.

Thus, the above mentioned problem is solved by a method for simultaneously drying and carbonating a mineral waste material comprising carbonatable calcium and/or magnesium compounds and/or silicate, aluminate or silicate-aluminate phases in a spray dryer, comprising the steps of providing a starting material slurry comprising the mineral waste material in the form of particles with a D₉₀≤500 μm and at least 15 wt.-% water; providing a hot gas comprising at least 4 Vol.-% CO₂ to the spray dryer; spraying the starting material slurry into the hot gas, wherein a temperature of ≥100° C. and a relative humidity of <50% are adjusted in the spray dryer; transforming the starting material slurry into a dry, carbonated product comprising calcium carbonate and/or one of silica gel or alumina gel or silica-alumina gel, and evaporated water; and separating the dry, carbonated product from the gas and evaporated water.

To simplify the description compounds are mostly named by the pure form, without explicit mentioning of solid solutions, foreign ion substitution and impurities etc. as are usual in technical and industrial materials. As one of ordinary skill in the art knows, the exact composition of the phases described may vary due to substitution with foreign ions. Such compounds are comprised when mentioning the pure form herein unless it is expressly stated otherwise.

The term “reactive” shall mean a hydraulic reactivity unless specified otherwise. Hydraulic reactivity designates the reaction of a compound with water or other water containing compounds to form hydrated phases including a reaction of two or more compounds occurring simultaneously.

Cement designates a material that, after mixing with an aqueous liquid to form a paste, can develop mechanical strength by hydraulic reaction. Thus, cement mostly denotes a clinker ground with or without further components, but also mixtures like super sulphated cement, geopolymer binder, and hydraulic materials not obtained by sintering like a dicalcium silicate obtained by hydrothermal treatment. Composite cement or binder means a mixture containing cement and a supplementary cementitious material. A cement, composite cement or binder is usually used adding water or another liquid and mostly also aggregate. Typically, admixtures and/or additives are added to the binder and/or the paste.

A supplementary cementitious material (abbreviated SCM) is defined as a pozzolanic and/or latent hydraulic material useful to replace a part of the clinker in a composite cement. Latent hydraulic materials have a composition that allows hydraulic reaction upon contact with water, wherein typically an activator is needed to enable hardening within technically feasible times. Activator means a substance that accelerates the hardening of latent hydraulic materials. It can be an addition like sulfate or calcium hydroxide, calcium oxide and/or products of the hydraulic reaction of the ground clinker, e.g. calcium silicates liberate calcium hydroxide during hardening. Pozzolanic materials are characterized by a content of reactive silica and/or alumina which form strength providing calcium silicate hydrates and calcium aluminate hydrates and calcium silicate aluminate hydrates, respectively, during hydration together with calcium ions, especially calcium hydroxide liberated from the cement. In practice the limit between latent hydraulic and pozzolanic materials is not well defined, for example fly ashes can be both latent hydraulic and pozzolanic depending on their calcium oxide content. Consequently, the term SCM designates both latent hydraulic as well as pozzolanic materials. However, non-reactive, or only slightly reactive materials like limestone that substantially do not take part in the hydraulic reactivity have to be clearly differentiated from SCM, with which they are sometimes summarized as mineral additions.

Hydraulically hardening building material means a wet mixture that is able to harden hydraulically and comprises a cement or binder as well as optionally any other addition contained to adjust the properties like final strength, processability of the wet mixture and strength development properties, to the intended use of the building material. For example, a concrete used to build a bridge needs other properties than a screed for casting a floor or a mortar for laying bricks.

Building structure denotes the hardened building material, e.g. a pre-cast concrete element or a floor or a bridge part from cast in place concrete.

Carbonation or carbonatization means a reaction with carbon dioxide, which can be supplied as gas, solution or solid, forming carbonates, possibly also hydrogen carbonates or other compounds comprising the CO₃²⁻ ion. The terms carbonation and carbonatization are used synonymously.

The term mineral waste material covers materials which are generated as by-products or waste in a technical or industrial process, e.g. during manufacturing of products like cement, during mining of natural minerals, during waste incineration or in recycling procedures. The designation as mineral waste material does not exclude the presence of organic matter and/or metals, nor is it restricted to natural minerals. To the contrary, organic matter and/or metal are frequent impurities and many mineral waste materials result from technical or industrial processe as synthetic (by-)product or waste.

The present invention proposes to use a carbon dioxide containing hot gas to carbonate and simultaneously dry a mineral waste material by spray drying. Spray drying is a technology known from the food, pharmaceutical and pigment industry for converting a solution or slurry into a dry powder by rapid drying with a hot gas. More precisely, the spray dryer receives a liquid stream and separates the solution or slurry into finely dispersed solid particles and evaporated solvent, typically water vapour. This process is very fast compared to other drying methods. The particles need a certain fineness to remain in the gas stream. According to the invention a gas rich in CO₂ is used as the hot gas, so that the mineral waste material particles are carbonated at the same time in a single pass.

In the first step of the method according to the invention a mineral waste material slurry is provided. In principle, all mineral waste materials comprising carbonatable calcium and/or magnesium compounds and/or or silicate, aluminate or silicate-aluminate phases able to be converted into silica gel or alumina gel or silica-alumina gel, respectively, by carbonation are suitable. Preferred are waste concrete, especially recycled concrete paste; waste sand-lime-brick or aerated concrete; by-products from cement production; by-products and wastes from gas treatment installations, especially fly ash; residues from combustion processes, especially bottom ash; slags; mine tailings from mining e.g. natural pozzolans, rocks, ores; and burned or hydrated lime containing waste like carbide lime.

The mineral waste material is preferably a material rich in carbonatable calcium and/or magnesium compounds. Rich in carbonatable calcium and/or magnesium compounds means that at least 12 wt.-% of the waste material/by-product calculated as oxides is CaO and/or MgO and at least 50 wt.-% of the CaO and MgO is in carbonatable compounds before carbonation. Preferably, CaO and/or MgO constitute at least 15 wt.-% and most preferred at least 20 wt.-% of the waste material. Preferably, at least 60 wt.-%, most preferred at least 75 wt.-% of the CaO and MgO are in carbonatable compounds. Thus, while a part of the carbonatable calcium and/or magnesium compounds in the mineral waste materials might be already carbonated before carbonation, at least 6 wt.-% of the material calculated as oxides should be carbonatable but not yet carbonated CaO and/or MgO.

Additionally or alternatively, the mineral waste material comprises silicate and/or aluminate and/or silicate-aluminate phases convertible into silica gel and/or alumina gel and/or silica-alumina gel by carbonation. In case the mineral waste material comprises no or only very little carbonatable calcium and/or magnesium compounds, the amount of silicate or aluminate or silicate-aluminate phases convertible into silica gel or alumina gel or silica-alumina gel by carbonation should be ≥5 wt.-%, preferably ≥10 wt.-%, most preferred ≥15 wt.-%, relative to the total waste material dry mass. When the mineral waste material is rich in carbonatable calcium and/or magnesium compounds, i.e. at least 6 wt.-% of it calculated as oxides is carbonatable but not yet carbonated CaO and/or MgO, the silicate or aluminate or silicate-aluminate phases convertible into silica gel or alumina gel or silica-alumina gel by carbonation form at least 2 wt.-%, preferably at least 5 wt.-%, most preferred at least 10 wt.-%, of the dry waste material relative to the total waste material dry mass excluding the MgO and CaO contained in these silicate/aluminate phases.

To ensure dispersion of the particles and fast carbonation the particles in the starting material slurry have a D₉₀≤500 μm, preferably ≤250 μm, more preferred ≤100 μm or ≤50 μm, most preferred ≤10 μm. If the mineral waste material has not the desired particle size distribution (abbreviated PSD), the PSD can be easily adjusted with methods and devices known per se. Suitable are for example but not limited to grinding, sieving, classifying or any combination of them. Particle size distributions are measured by sieving for sizes above 2 mm herein and determined by laser granulometry with a Mastersizer (Malvern Panalytical Ltd., GB) according to the Fraunhofer theory for sizes below 1 mm, in isopropanol dispersion, Dₓₓ values are volume based. In the 1-2 mm range the method is chosen depending on the particle size range of the material. For ranges extending mainly above 1 mm sieving is commonly applied, for ranges extending mainly below 1 mm laser granulometry is typically better. The D₅₀ of the particles in the starting material slurry ranges preferably from 0.1 to 250 μm, more preferred from 0.5 to 100 μm, most preferred from 1 to 5 μm.

The starting material slurry preferably has a solid:liquid mass ratio from 2:1 to 1:20, more preferred from 1:1 to 1:10, most preferred from 1:3 to 1:5. The actual ratio depends on other conditions like PSD, heat availability, and nature of the solids, especially the pumpability. The slurry contains a least 30 wt.-% water, preferably at least 35 wt.-%, most preferred at least 50 wt.-%. A water content above 95 wt.-% would not contribute to carbonation or ease pumping and conveying of the slurry. Instead, it needs additional energy to remove the water during the combined spray drying and carbonation. Therefore, the water content is preferably adjusted to ≤90 wt.-%, more preferred ≤85 wt.-%, most preferred ≤80 wt.-%. If the mineral waste material is obtained as dry material or with less than 30 wt.-% water, a suitable amount of water is added. It is also possible and may be preferred to mix dry mineral waste material with mineral waste material in the form of a slurry to adjust the water content. If available, concrete residual water can advantageously be used as water. When the mineral waste material contains more water than desired for the starting material slurry, it can be concentrated by filtration, sedimentation etc. or mixed with dry waste material. It is not preferred to use a concentration step if that causes significant costs or effort. In such cases the benefits of a concentration have to be weighed against the cost and effort to remove the additional water during the combined carbonation and drying according to the invention.

As mentioned, recycled concrete paste is a preferred mineral waste material. Waste concrete obtained as known per se is used to obtain the RCP. Waste concrete covers all materials that occur in the use of cement, binder and hydraulically hardening building materials. One typical example is concrete demolition waste. Further examples are remains from hydraulically hardening building materials, like concrete and mortar prepared and then superfluous, and solid parts in the waste from cleaning devices for concreting, like concrete trucks, mortar mixers, and moulds for precast concrete parts.

One preferred waste concrete is concrete demolition waste. Concrete demolition waste designates the crushed material obtained during demolition of concrete containing structures like buildings and road surfaces from which the foreign materials like wood, metal parts, brick parts, and plastic, have been substantially completely removed, while presence of sand-lime-brick or aerated concrete is feasible. According to the invention, the fines resulting from concrete demolishing are useful to provide starting material slurry because they contain high amounts of RCP. Recycled concrete fines (abbreviated RCF) designates the material obtained after crushing concrete demolition waste and separating the particles reusable as aggregate and, if applicable, any foreign matter contained. The exact composition and particle size distribution of the concrete fines depends on the original binder and composition used in the concrete and on the demolishing and grinding procedures applied. Usually, the original aggregate is separated as much as possible and the RCF contains mostly the ground RCP together with fine sand/aggregates, which are usually present in amounts of 30 to 80 wt.-% of the total material weight. Preferably, RCF with at least 30 wt.-% RCP, more preferred at least 40 wt.-% and most preferred at least 50 wt.-% is used to provide the starting material slurry according to the invention.

Another preferred waste concrete is concrete residues arising during building, e.g. but not limited to unused ready mix concrete and left over mortar. The residues are crushed to separate hardened cement paste from aggregate, and the finer fraction obtained—optionally after grinding—is used to provide the starting material slurry according to the invention. Also cement that has been stored too long and partially hydrated (e.g. when 5% or more of the cement is hydrated) is useful, if needed after crushing and/or grinding. Further, the waste arising during cleaning of devices used in concreting, e.g. molds for manufacturing pre-cast concrete elements, especially the filter cake from pre-cast plants, is suitable, if needed after crushing and/or grinding. With all these preferably at least 30 wt.-% RCP, more preferred at least 40 wt.-% and most preferred at least 50 wt.-% should be present in the material used to provide the starting material slurry. Therein, RCP includes the unreacted cement if such is present. With other words, as far as hydraulic phases like belite, alite, ferrite etc. are present in the waste concrete, their amount is taken into account for calculating the content of RCP.

It is advantageous when the RCP contains high amounts of hardened paste, e.g. at least 30 wt.-%, or at least 40 wt.-%, or at least 50 wt.-%, or at least 60 wt.-%, or at least 70 wt.-%, or at least 75 wt.-%.

The starting material slurry can be provided from one waste concrete or by mixing and/or co-grinding several waste concrete materials as well as other materials rich in carbonatable Ca and/or Mg compounds and/or silicate and alumino-silicate materials. Typically, it is easier to use only one source, but using two or more allows optimization of the composition and converting otherwise unsuitable materials, i.e. ones that could not be used on their own. In one embodiment the starting material slurry is obtained from one waste concrete or from a mixture of two or more waste concretes as sole mineral waste material.

Another preferred mineral waste material used to provide the starting material slurry is ash. Ashes are typical by-products and wastes from gas treatment installations or residues of combustion processes. In particular fly ash from exhaust gas dedusting or bottom ash arising in power plants or waste incineration are useful. As far as fly ash fulfills the requirement of the standards for use as SCM, e.g. EN 197-1:2011 or ASTM C618, it is not necessary to carbonate it. However, numerous fly ashes fail to show the required properties. Those fly ashes benefit from the method according to the invention. The same applies to bottom ashes which more often than not have a too low pozzolanic reactivity and cannot be used as SCMs according to the current rules. Those ashes usually contain a glassy phase of less than 60%, more often less than 40% of the total mass of ash. The remaining fraction of ash is made up of a variety of crystalline phase. Bottom ashes typically comprise: silicon dioxide (SiO₂) from 21-60 wt.-%, aluminum oxide (Al₂O₃) from 10-37 wt.-%, calcium oxide (CaO) from 0-27 wt.-%, magnesium oxide (MgO) from 0-4 wt.-%, ferric oxide (Fe₂O₃) from 5-37 wt.-%. The specific gravity of bottom ash usually ranges from 1.94 to 3.46, more often from 2.0 to 3.2 g/cm³.

A further preferred mineral waste material to provide the starting material slurry is slag, especially slag from steel making. Steel slags are usually classified according to the type of furnace in which they are produced. The properties of the slag depend on the type of process used to produce the crude steel, the cooling conditions of the slag and the valorisation process. In the primary process, crude steel is produced in two ways. In the first method, the iron is produced from ore in the blast furnace, thus, generating blast furnace slag. Basic oxygen furnace slag is produced in the steelmaking process by using the molten iron coming from the blast furnace. In the second method, slags are generated in the scrap-based steel industry. The first stage of the scrap-based steel industry production generates electric arc furnace slag, and a second stage is performed to refine the molten steel generating ladle furnace slag. This slag is the result from steel refining and, therefore, it is generally a heavy metal carrier containing heavy metals such as chrome, lead or zinc. Table 7.1 from www.sciencedirect.com/topics/engineering/steel-slag, reproduced here as table 1, shows the following characteristics of the main slag types generated by the crude steel industry:

TABLE 1
(amounts of the oxides in wt.-%)

| | | | | Basic | Electric | Electric | |
|---|---|---|---|---|---|---|---|
| | | air | blast | oxygen | arc | arc | Ladle |
| | | cooled | furnace | furnace | furnace | furnace | furnace |
| slag | | slag | slag | slag | slag I | slag II | slag |
| com- | CaO | 30-45 | 30-45 | 30-50 | 40-50 | 20-40 | 35-60 |
| posi- | SiO₂ | 30-40 | 30-40 | 10-15 | 25-30 | 10-20 | 5-50 |
| tion | Al₂O₃ | 10-15 | 10-15 | 1-3 | 2-10 | 2-10 | 1-30 |
| | MgO | 5-15 | 5-15 | 5-15 | 3-10 | 5-15 | 4-18 |
| | Fe | 0-1 | 0-1 | 10-30 | 0-2 | 20-40 | 0-5 |
| | (total) | | | | | | |
| | SO₃ | 0-2 | 0-2 | 0.1-0.3 | 0-2 | 0.1-0.5 | 0-3 |
| | MnO | 0-1 | 0-1 | 1-5 | 1-3 | 2.5-5 | 0-2 |
| | TiO₂ | — | — | 0.5-2 | 0-1 | 0.5-1 | 0-3 |
| | P₂O₅ | 0-0.1 | 0-0.1 | 1-3 | — | 0.5-2 | 0-0.5 |
| | Free | — | — | 2-10 | — | 0.5 | 0.5-20 |
| | CaO | | | | | | |
| Density | | 2.5 | | 3.3 | | 3.5 | 2.6 |
| (g/cm³) | | | | | | | |
| Processing | | Slow cool- | Rapid | Slow cool- | Slow cool- | Slow cool- | Slow cool- |
| | | ing (air | cooling | ing, crush- | ing, crush- | ing, mois- | ing, mois- |
| | | cooled), | (water | ing, siev- | ing, siev- | tened, | tened, |
| | | crushing, | cooled), | ing | ing | crushing, | crushing, |
| | | sieving | gridding | | | sieving | sieving |
| | | | (100 μm) | | | | |
| Application | | Concrete | Cement, | Concrete | Cement | Concrete | pH stabi- |
| | | and road | concrete | and road | addition | and road | liser, |
| | | aggregate | addition | aggregate | and con- | aggregate | roads, ce- |
| | | | | | crete | | ment |
| Main | | Crystalline, | Vitreous, | Crystalline, | Crystalline, | Crystalline, | Crystalline |
| properties | | density, | hydraulic | strength, | strength, | strength, | |
| | | strength | | high skid | high skid | dense, | |
| | | | | resistance | resistance | high skid | |
| | | | | | | resistance | |

Blast furnace slag is usually fulfilling the requirements of the standards for use as SCM, e.g. EN 197-1:2011 or ASTM C618, so it is not necessary to carbonate it. But the other slags are typically not suitable as SCM in the form in which they are obtained and benefit from the method according to the invention.

Furthermore, slags obtained in metal recovery processes and scrap recycling processes are suitable. Those typically comprise an X-ray amorphous content below 50 wt.-%, often below 40 wt.-% or below 30 wt.-%. Also other slags with a low content of X ray amorphous component(s) are suitable. The basicity B₁ defined as the weight ratio CaO to SiO₂ of those slags is ranging from 1.38 to 22.64. The basicity B₂ which also takes into account MgO for steel slags usually ranges from 1.55 to 16.22. The basicity B₃ additionally considering Al₂O₃ for steel slags usually ranges from 1.08 to 3.17. The basicity B₄ defined as weight ratio CaO to Fe₂O₃ for steel slags typically ranges from 0.65 to 20.27. The basicity B₁, B₂, B₃ and the ratio CaO to Fe₂O₃ B₄ are determined by the following equations:

B₁=CaO/SiO₂

B₂=(CaO+MgO)/SiO₂

B₃=(CaO+MgO)/(SiO₂+Al₂O₃)

B₄=CaO/Fe₂O₃

In addition, slags from metallurgical processes like manganese production or copper production with sufficient calcium and magnesium content benefit from the method according to the invention. Such slags usually have a basicity B₁ ranging from 0.2 to 1.1 and/or a basicity B₂ ranging from 0.2 to 1.1. Manganese slags moreover typically contain MnO contents higher than 1 wt.-%, more often higher than 3 wt.-%, measured by X-ray fluorescence spectroscopy.

Still another preferred mineral waste material is mine tailings arising in the mining of for example but not limited to natural pozzolans, rock, and ore. Preferred are mine tailings from mining basalt, olivine and other silicate rocks. Quarry dusts created during mining and during crushing the mined minerals are also suitable. Likewise, water comprising fines from washing the mined rock and ore can be used, provided they contain mineral waste material fulfilling the requirements listed above.

Furthermore, by-products and waste from cement production are useful mineral waste materials, for example, but not limited to cement kiln dust, cement bypass dust, and dusts or slurries from the gas cleaning systems. These materials often contain decalcified limestone or other carbonatable high-temperature clinker minerals, which prevents their usage in cement due to their high reactivity. After the carbonation, they can be used in cement and concrete production as reactive SCMs.

Another suitable mineral waste material is burned or hydrated lime containing waste, e.g. carbide lime. Carbide lime occurs when acetylene is produced from carbide, mostly calcium carbide. Other suitable materials are residues from making or using lime mortar, lime plaster, lime render, lime-ash floors, tabby concrete, whitewash, silicate mineral paint, and/or limestone blocks. Fractions containing those occurring in demolition of buildings and structures are also suitable.

As mentioned before with regard to RCP, the starting material slurry can be obtained from a mixture of two or more mineral waste materials. Thereby, both chemical composition and water content can be easily adjusted. For example, a mixture of one or more dry ashes with washing water arising during cleaning of devices used in concreting or a mixture of dry recycled concrete fines with washing water from aggregate provides a starting material slurry with suitable chemical composition and water content.

It is possible to include one or more additional materials into the starting material slurry which accelerate the carbonation process and/or improve the final properties of the dry, carbonated product or the composite cement or binder or building material made with it. Typically, additional material will be included in an amount from 0.001 to 1 wt.-% with respect to the total amount of dry starting material. Usually, substances that improve the properties of the composite cement or hydraulic building material are added to the cement or building material, but some can also accelerate the carbonation. In the latter case their addition to the starting material slurry is advantageous. Preferably, substances for enhancing the carbonating process or mixtures of two or more thereof are used as additional material.

Suitable materials include substances that improve dissolution of CO₂ in water like metal hydroxides, amines, halogenides, ethylenediaminetetraacetic acid and others. Especially suitable amines are alkanolamines, for example primary amines like monoethanolamine and diglycolamine, secondary amines like diethanolamine and diisopropanolamine, and tertiary amines like methyldiethanolamine and triethanolamine, or mixtures thereof. Additionally, enzymes such as carbonic anhydrase can be used to enhance carbonation efficiency and modify the properties of the reaction products. It is to be noted that these additions may have not only one action but can exercise a double role. They can e.g. modify the hydration process of the final binder as well as modify the carbonation process. The effect can largely depend on the dosage.

Moreover, it is possible to add substances that regulate the pH during the carbonation process in order to enhance the precipitation of calcium carbonate. These include metal hydroxides and carbonates and similar substances.

Further, it is possible to add substances that modify the morphology of the precipitating calcium carbonate during the carbonation process. This provides the advantage of forming less dense shells of hydrates-carbonates product and enables higher carbonation and hydration degrees. Suitable are for example magnesium salts, polyacrylic acid, polyacrylamide, polyvinyl alcohol, polyvinylsulfonic acids, styrene sulfonate, citric acid and other organic acids, polysaccharides and phosphonates, polycarboxylates.

As mentioned, it is also possible to add admixtures that modify properties of the hydraulic building material or the building structure made from the composite cement or binder comprising the dry, carbonated product obtained according to the invention already to the starting material slurry (usually those will be added to the composite cement or binder or building material).

Often used admixtures are water reducing agents and plasticizers like for example, but not exclusively, organic compounds with one or more from carboxylate, sulfonate, phosphonate, phosphate or alcohol functional groups. These serve to achieve a good consistency, i.e. flowability, of the paste with a smaller amount of water. Since a decrease of water/binder ratio normally provides an increase of strength, such admixtures are commonly used.

Air entraining agents are also able to improve flowability and can be used for this aim or for other reasons such as, but not limited to, density modifications, compactibility improvements etc. Useful air entraining agents are e.g. surface active substances, especially ones based on soaps from natural resins or synthetic nonionic and ionic surfactants.

Other admixtures that influence workability are retarders. They mainly aim at prolonging the time that a specified consistency is maintained. Retarders slow the setting and/or hardening of the binder paste. Suitable substances are for example, but not exclusively, phosphates, borates, salts of Pb, Zn, Cu, As, Sb, lignosulphonates, hydroxycarboxylic acids and their salts, phosphonates, sugars (saccharides).

It is also possible to add admixtures that are designed to modify the rheology properties, i.e. rheology modifiers like polycarboxylates, lignosulfonates, starch, Karoo gum, bentonite clay, polyvinyl alcohol, and mixtures thereof.

All admixtures are used in the amounts known as such, wherein the amount is adapted to a specific binder and special needs in the known manner.

Additives can be added as well to the carbonation step, but usually those are added to the composite cement, binder or hydraulic building material. Usual and useful additives are e.g. fillers (especially limestone and other stone dusts), pigments, reinforcing elements, self-healing agents etc. All these can be added in the amounts known per se.

Not prior published EP 21176008.7 proposes a combination of hydrothermal treatment and carbonation to enhance and accelerate the carbonation of recycled concrete paste increasing its CO₂ uptake and activating also parts of the contained aggregates to become reactive as SCM in the case of silicate and/or alumino-silicate containing aggregate. Thus, in one preferred embodiment, the mineral waste material is pretreated in an autoclave as described in EP 21176008.7. Specifically, the mineral waste material is hydrothermally treated, i.e. heated in the presence of water. The water-solid weight ratio in the aqueous mixture is equal to or larger than 0.1. Preferably, the water-solid ratio is in the range from 0.25 to 4 and more preferred from 0.3 to 2.0. The amount of water is adjusted such that a full hydration of the solids can be achieved. The temperature during the hydrothermal treatment is usually set in the range from 25 to 400° C., preferably in the range from 75 to 350° C. According to a particularly preferred embodiment the temperature is in the range from 75 or 100 to 300° C. or 250° C. The pressure during the hydrothermal treatment is preferably endogenous, i.e. the pressure that sets itself during the treatment at the selected temperature. It can also be kept constant. Typically the pressure is in the range from 1 to 25 bar, preferably from 2 to 20 bar. All pressures indicated herein are absolute pressures. It is possible to carry out the hydrothermal treatment under stirring and/or grinding to prevent settling of the solids and/or to provide fresh, non-reacted surface area. The treatment can last from minutes to hours depending on the specific mineral waste material(s) used, the pressure, the temperature and additional material if such is added. Typically the treatment time may vary from 30 minutes to 48 hours. According to a particular embodiment, it is in the range from 2 to 36 hours. The slurry resulting from a hydrothermal treatment can be used as is as starting material slurry. If necessary, the water content is adjusted to at least 30 wt.-% by adding water and/or one or more other mineral waste material slurries. A concentration step removing some of the water is applied if needed, wherein processes with low energy demand like decanting are preferred over such with high energy demand like drying.

To simultaneously dry and carbonate the starting material slurry is sprayed into a spray dryer in a manner known per se, i.e. it is conveyed to a suitable nozzle and sprayed into the hot gas. Any spray dryer known per se can be used. Details of suitable configurations are described e.g. in U.S. Pat. No. 4,187,617 A and EP 2 406 363 B1. As a rule, the spray dryer comprises a nozzle to which the slurry is supplied and a feed for the hot gas. The slurry is dispersed into small droplets by the nozzle and introduced into the spray dryer chamber. Therein, water evaporates and the dried product is collected with a particle separator. The hot gas mixes with the evaporated water and cools down. The gas can be partially recirculated as long as it is hot and dry enough and correspondingly is partially removed or totally removed after it has been separated from the particles constituting the dry, carbonated product. Practical applications use preferably a single-pass of the hot gas with a heat exchanger to utilize the contained heat when the temperature of the removed gas is still high.

The hot gas can be supplied in co-current flow, i.e. in the same direction as the dispersed slurry droplets, or in counter-current flow, i.e. against the flow of the droplets. With co-current flow, the particles spend less time in the system and in the particle separator (usually a cyclone device). With countercurrent flow, the particles can spend more time in the system. In particular, wet particles have a higher density and hover at the bottom of the spray dryer. When they dry they become lighter and move to the top. This extended residence time makes it easy to achieve a high carbonation degree without the hassle of wet or semi-dry carbonation. Instead, the materials can be carbonated directly in the spray dryer.

The hot gas contains at least 4 Vol.-% CO₂, preferably from 7 to 100 Vol.-%, most preferred from 12 to 99 Vol.-%. A flue gas is especially advantageous as hot gas. Thereby, the drying and carbonation additionally sequesters CO₂ from the flue gas. Preferably, the flue gas is exhaust gas from cement plants, lime plants, coal fired power plants, gas fired power plants, and/or waste incinerators. Especially advantageous is gas with biogenic CO₂ such as e.g. from biomass or biogas plants. The exhaust gas is typically used directly according to the invention, i.e. with no cleaning and CO₂ concentrating steps. Mixtures of exhaust gases from different sources can be used. But a transportation of the exhaust gas over long distances is not preferred, i.e. preferably it should be possible to pass the exhaust gas into the spray drying via pipes and/or tubing. Capturing in tanks as well as storage and transportation of such tanks causes additional effort and possibly carbon dioxide emission. Therefore, integrating the spray drying and carbonation step with the exhaust gas producing process—even if a pipeline of some length is needed—or with other words, direct use of the exhaust gas, is most preferably applied according to the invention. Gas containing biogenic CO₂ is especially advantageous as the resulting material can be carbon negative.

According to the invention, the relative humidity inside the spray dryer, more specifically inside its drying chamber, is adjusted to below 50% preferably to 30% or lower. The fine particles and the intimate contact with the hot gas render such a low relative humidity fully sufficient for carbonation. In other words, it is not necessary to carbonate the waste material in aqueous suspension or with comparably high humidity as was previously assumed. The relative humidity of the gas change during its passage through the spray dryer: it is very low at the inlet where the gas is hot and dry and becomes higher at the outlet as the gas cools down and the water from slurry evaporates. Practically, for a given gas composition and temperature, the adjustment of the gas flow ensures the desired drying/carbonation kinetics with a relative humidity at the gas outlet below 50%, likely below 30%.

The temperature can be varied within wide ranges, suitable are e.g. ≥100° C. or ≥130° C. or ≥150° C. to ≤800° C. or ≤600° C. or ≤400° C. It is preferred to use the heat contained in the flue gas without or with only little heating to save energy and thereby carbon dioxide emission. However, if an already cooled flue gas or another gas containing carbon dioxide with a temperature below 100° C. shall be used as the hot gas, it is of course heated to the chosen temperature. For heating a gas to provide the hot gas with the desired temperature any known heating method and device are suitable. Preferably, heat exchange and/or heating with secondary fuels is used. It is also envisaged to heat recirculated gas to be used as the hot gas and/or to adjust the temperature of the hot gas by heating it.

The pressure inside the spray dryer is preferably ambient pressure. It is also possible to use a few hundred mbar overpressure or underpressure as is common in industrial processes. Specifically, the pressure can be from 10 to 300 mbar above or below ambient pressure, preferably from 50 to 150 mbar, resulting from action of suction or discharging fans or similar devices to move gas.

The carbonation degree achieved during the spray drying should be at least 30 wt.-%, preferably at least 50 wt.-% and most preferred at least 70 wt.-% of the carbonatable calcium and/or magnesium compounds comprised in the starting material slurry. In some cases carbonation of almost 100 wt.-% of the carbonatable calcium and/or magnesium compounds is achieved, e.g. >99 wt.-%.

The hot gas can contain minimal amounts of moisture, e.g. up to 7 wt.-% or up to 5 wt.-% or up to 3 wt.-% water. It is envisaged to add water or steam to substantially dry hot gas, especially when the starting material slurry contains a comparably low amount of water like from 30 to 40 wt.-%. Thereby, the carbonation degree is optimized. A water content of the hot gas at the inlet from 1 to 3 wt.-% is typically adjusted.

The separation of the gas from the dry, carbonated particles takes place in a particle separator known per se. Preferred are cyclone devices completed with bag filters. As mentioned before, the gas can be totally removed, which is usually preferred, or partially recirculated.

The particles obtained from the particle separation step are the dry, carbonated product comprising calcium/magnesium carbonate and/or one or more of silica gel or alumina gel or silica-alumina gel. This product is useful as SCM in composite cement or for adding to hydraulic building materials. Provided the waste material contained a significant amount of silicates, aluminates or silicate-aluminates it is further useful as the silicate component of alkali activated binders.

Composite cements, hydraulic building materials and alkali activated binders comprising the dry, carbonated product are made in the usual way with their usual further components.

Thus, the method according to the invention provides composite cements, alkali activated binders and hydraulic building materials that can be used in the same way and for the same applications as known cements, alkali activated binders and hydraulic building materials. However, such cements, binders and building materials have significantly reduced carbon dioxide footprint and preserve natural resources. The mineral waste materials used to provide the starting material slurry according to the invention find no or only very limited use so far. Flue gas is abundant and using it as the hot gas utilizes its heat as well as achieves a pre-cleaning that eases further treatment steps like capturing the carbon dioxide for storage and/or utilization.

The invention will be illustrated further with reference to the examples that follow, without restricting the scope to the specific embodiments described. The invention includes all combinations of described and especially of preferred features that do not exclude each other.

If not otherwise specified any amount in % or parts is by weight and in the case of doubt referring to the total weight of the composition/mixture concerned. A characterization as “approximately”, “around” and similar expression in relation to a numerical value means that up to 10% higher and lower values are included, preferably up to 5% higher and lower values, and in any case at least up to 1% higher and lower values, the exact value being the most preferred value or limit. The term “substantially free” means that a particular material is not purposefully added to a composition and is only present in trace amounts or as an impurity. As used herein, unless indicated otherwise, the term “free from” means that a composition does not comprise a particular material, i.e. the composition comprises 0 weight percent of such material.

### EXAMPLE 1

Recycled concrete paste obtained according to US 2016/0046532 A1 as a slurry from the carbonation grinding of recycled concrete and filtering off the cleaned aggregate is used as the starting material slurry. The slurry contains 60 wt.-% water and the solids comprise about 40 wt.-% fine aggregate and about 60 wt.-% hardened cement paste. Thus, approximately 30 wt.-% calcium calculated as CaO is contained in carbonatable compounds, namely the C—S—H gel, calcium hydroxide, AFt and AFm phases, other hydrates and unreacted clinker minerals. Tertiary air from a cement kiln is used as the hot gas. The hot gas contains about 16 Vol.-% CO₂ as well as 12 Vol.-% H₂O (about 2% relative humidity at 175° C.). Both slurry and gas enter the spray dryer at the inlet. Due to the temperature of the hot gas of about 175° C. the drying chamber of the spray dryer has a temperature from 165° C. at the inlet to 130° C. at the outlet. Within the average residence time of 7 seconds the particles are travelling from the inlet nozzle to the outlet end they are dried and 50 wt.-% of the contained carbonatable calcium compounds are carbonated. The relative humidity in the drying chamber is approximately 2% at the gas inlet and 11% at the gas outlet.

### EXAMPLE 2

Calcareous fly ash is used as the starting material in the slurry. The slurry contains 30 wt.-% water. Approximately 23 wt.-% calcium calculated as CaO is contained in carbonatable compounds in the slurry. Tertiary air from a cement kiln is used as the hot gas. The hot gas contains about 22 Vol.-% CO₂ as well as 14 Vol.-% H₂O (about 4% relative humidity at 156.9° C.). Both slurry and gas enter the spray dryer at the inlet. Due to the temperature of the hot gas of about 157° C. the drying chamber of the spray dryer has a temperature from 145° C. at the inlet to 120° C. at the outlet. Within the average residence time of 7 seconds the particles are travelling from the inlet nozzle to the outlet end they are dried and 70 wt.-% of the contained carbonatable CaO is carbonated. The relative humidity in the drying chamber is approximately 4% at the gas inlet and 16% at the gas outlet.

### EXAMPLE 3

Dredged sediments as a slurry are used as starting material slurry. The slurry contains 35 wt.-% of water. Approximately 20 wt.-% calcium calculated as CaO is contained in carbonatable compounds in the slurry, a part of which has been added as burned lime to stabilize and sanitize the slurry. Tertiary air from a cement kiln is used as the hot gas. The hot gas contains about 19 Vol.-% CO₂ as well as 11 Vol.-% H₂O (about 2% relative humidity at 171° C.). Both slurry and gas enter the spray dryer at the inlet. Due to the temperature of the hot gas of about 171° C. the drying chamber of the spray dryer has a temperature from 160° C. at the inlet to 125° C. at the outlet. Within the average residence time of 7 seconds the particles are travelling from the inlet nozzle to the outlet end they are dried and 60 wt.-% of the contained carbonatable CaO is carbonated. The relative humidity in the drying chamber is approximately 3-% at the gas inlet and 14% at the gas outlet.

1. A method for simultaneously drying and carbonating a mineral waste material, the mineral waste material comprising carbonatable calcium compounds and/or carbonatable magnesium compounds and/or silicate, aluminate or silicate-aluminate phases able to be converted into silica gel, alumina gel or silica-alumina gel respectively by carbonation, in a spray dryer, wherein
a starting material slurry is provided comprising the mineral waste material in the form of particles with a D₉₀≤500 μm and at least 30 wt.-% water,
a hot gas is provided comprising at least 4 Vol.-% CO₂ and fed into the spray dryer
the starting material slurry is sprayed into the hot gas in the spray dryer wherein a temperature of ≥100° C. and a relative humidity of <50% at the outlet are adjusted in the spray dryer
the starting material slurry is transformed into evaporated water and a dry, carbonated product comprising calcium and/or magnesium carbonate and/or at least one of silica gel or alumina gel or silica-alumina gel, and
the dry, carbonated product is separated from the gas and evaporated water.

2. The method according to claim 1, wherein the mineral waste material is waste concrete, especially recycled concrete paste; waste sand-lime-bricks; waste aerated concrete; by-products from cement production; by-products and wastes from gas treatment installations; residues from combustion processes; slags; mine tailings from mining natural pozzolans, rocks, ores; burned or hydrated lime containing waste; and mixtures of two or more thereof including mixtures of two or more waste concretes; by-products from cement production; by-products and wastes from gas treatment installations; residues from combustion processes; slags; mine tailings from mining natural pozzolans, rocks, ores; and burned or hydrated lime containing wastes.

3. The method according to claim 2, wherein the mineral waste material is selected from the group consisting of recycled concrete paste, waste sand-lime-bricks, waste aerated concrete, fly ash, bottom ash, mine tailings from mining silicate rocks, steel slags, carbide lime, and mixtures of two or more thereof.

4. The method according to claim 1, wherein the particles in the starting material slurry have a D₉₀≤250 μm, and/or the D₅₀ ranges from 0.1 to 250 μm.

5. The method according to claim 1, wherein the starting material slurry has a solid:liquid mass ratio from 2:1 to 1:20, and/or a water content≥35 wt.-% and/or a water content≤95 wt.-%.

6. The method according to claim 1, wherein the temperature in the spray dryer ranges from 100° C. to 800° C.

7. The method according to claim 1, wherein the relative humidity in the spray dryer is ≤30%.

8. The method according to claim 1, wherein the hot gas contains at least 7 Vol.-% CO₂.

9. The method according to claim 1, wherein the hot gas is an exhaust gas from a cement plant, a lime plant, a coal or gas fired power plant, and/or a waste incinerator or biomass incinerator.

10. The method according to claim 1, wherein the pressure in the spry dryer is ambient pressure or from 10 to 300 mbar overpressure or underpressure.

11. The method according to claim 1, wherein at least one additional material is added to the starting material slurry, wherein the at least one additional material accelerates the carbonation process and/or improves the final properties of the dry, carbonated product or the composite cement or binder or building material made with it.

12. The method according to claim 1, wherein the mineral waste material is hydrothermally treated in an autoclave before the simultaneous carbonation and drying.

13. The method according to claim 12, wherein during hydrothermal treatment a water-solid weight ratio is equal to or larger than 0.1 and/or a temperature ranges from 25 to 400° C. and/or the pressure is endogenous.

14. The method according to claim 3, wherein the starting material slurry has a solid:liquid mass ratio from 1:1 to 1:10, and/or a water content≥50 wt.-% and/or a water content≤85 wt.-%.

15. The method according to claim 3, wherein the temperature in the spray dryer ranges from 130° C. to 600° C.

16. The method according to claim 14, wherein the temperature in the spray dryer ranges from 150° C. to 400° C. and the relative humidity in the spray dryer is ≤30%.

17. The method according to claim 3, wherein the hot gas contains from 12 to 99 Vol. % CO₂.

18. The method according to claim 17, wherein the hot gas is an exhaust gas from a cement plant, a lime plant, a coal or gas fired power plant, and/or a waste incinerator or biomass incinerator.

19. The method according to claim 14, wherein the hot gas contains from 12 to 99 Vol. % CO₂ and is an exhaust gas from a cement plant, a lime plant, a coal or gas fired power plant, and/or a waste incinerator or biomass incinerator.

20. The method according to claim 6, wherein the starting material slurry has a solid:liquid mass ratio from 2:1 to 1:20, and/or a water content≥35 wt.-% and/or a water content≤95 wt.-%.
